(19) United States
(12) Patent Application Publication
(10) Pub. No.: US 2013/0270180 A1
(43) Pub. Date: Oct. 17, 2013

(54) CERAMIC NANOWIRE MEMBRANES AND METHODS OF MAKING THE SAME

(71) Applicants: Xinjie Zhang, Winchester, MA (US); Anthony E. Allegrezza, JR., Milford, MA (US); Qi Zhao, Nishayuna, NY (US); Zhilong Wang, Woburn, MA (US)

(72) Inventors: Xinjie Zhang, Winchester, MA (US); Anthony E. Allegrezza, JR., Milford, MA (US); Qi Zhao, Nishayuna, NY (US); Zhilong Wang, Woburn, MA (US)

(73) Assignee: NOVARIALS CORPORATION, Woburn, MA (US)

(21) Appl. No.: 13/881,016

(22) PCT Filed: Oct. 28, 2011
(86) PCT No.: PCT/US2011/058232

§ 371 Date: Jul. 8, 2013

Related U.S. Application Data
(60) Provisional application No. 61/456,093, filed on Oct. 28, 2010.

(51) Int. Cl. B01D 71/02

(52) U.S. Cl. CPC B01D 71/024
USPC 210/500.25; 156/60

(57) ABSTRACT

Embodiments of the present invention disclose ceramic membranes having bonded ceramic nanowires. Methods of making ceramic membranes having bonded ceramic nanowires are also disclosed.

### PRIORITY CLAIMS AND RELATED APPLICATIONS

This application claims the benefit of international application No. PCT/US11/58232, filed Oct. 28, 2011, which claims the priority of U.S. provisional patent application Ser. No. 61/456,093, filed Oct. 28, 2010.

### GOVERNMENT SUPPORT

This invention was made with government support under NSF Grant IIP-0910419 and IIP-1026642 awarded by National Science Foundation. Accordingly, the government has certain rights in this invention.

### TECHNICAL FIELDS OF THE INVENTION

Embodiments of the present invention provide for a membrane produced from ceramic nanowires, preferably using titanium dioxide as the starting material, methods of making the nanowires and methods of producing the membranes.

### BACKGROUND OF THE INVENTION

Synthetic membranes, that is, man-made non-biological membranes, make up a multi-billion dollar a year business. Membranes are made in many formats and used in a variety of applications in separation technology. Membranes are commonly designated by what they separate. Separation is the relative passage of one type of species through a membrane compared to another type of species when a solution or mixture of the two types of species is imposed on the membrane. Separation membranes are useful in a variety of applications from small disks used in laboratory procedures to large scale industrial purification or separation processes. In the larger processes, membranes are incorporated into modules and the modules are combined into a process train.

Size separation membranes, size exclusion membranes, or sieving membranes all refer to membranes which retain species in a fluid carrier stream by passing the carrier through a membrane with pore diameters smaller than the species to be retained. This class of membranes is constituted by microporous and ultrafiltration membranes. Microporous membranes remove particles and bacteria in the submicron size range. Microporous membranes are rated by pore size, and are commonly made in rated pore sizes of from about 0.1 micron to about 8-10 microns, but usually <1 micron. Ultrafiltration membranes separate virus particles from water or biotherapeutic solutions and are used to concentrate proteins in biotherapeutic manufacturing processes and are used in dairy processes to produce concentrated whey. Ultrafiltration membranes are usually rated by the molecular weight of the smallest molecule that is retained at a specified retention, say 90% or 95%. In terms of pore size they range from about 10 nm to about 100 nm, although they may extend over either end of the range.

Most synthetic sieving membranes are made from polymers. Commonly used polymers to make sieving membranes are polyether sulfone, polyethylene, polypropylene, polytetrafluoroethylene, polyvinylidene fluoride, cellulose acetate, aromatic polyesters, polyether ether ketone (PEEK), and several nylons (polyamides). Polymeric membranes can be made in many pore sizes, are physically robust and can be formed into many forms (flat sheet, hollow fiber, tubular) by different manufacturing processes. They are, however, limited to operating temperatures below 300° C. and not able to be used in many organic solvents.

Ceramic materials have been used to produce membranes, including sieving membranes. Ceramics used to make membranes may comprise TiO₂, SiO₂, ZrO₂, Al₂O₃, W₂O₃ or mixtures of these. Ceramic membranes are useful for applications under harsh chemical and/or thermal conditions. However, they are limited by their high costs and tendency to brittleness. There is, therefore, a need for flexible, robust, low cost ceramic sieving membranes.

In recent years a new class of materials has been studied. These are called one-dimensional (1D) materials because they have one dimension that dominates the structure and the other two dimensions are on the order of nanometers. Nanowires, nanotubes, nanofibers or nanoscaled fibers are all part of the class of materials termed 1D materials or quasi-one dimension materials. Typically they have a diameter or cross-section of from about 5 nm to less than 500 nm and lengths of tens to hundreds of microns.

Nanowires, sometimes called nanofibers or nanobelts, can be made from a variety of materials, as described, for example in Nanowires and Nanobelts; Materials, Properties and Devices; Nanowires and Nanobelts of Functional Materials; Volume II Ed. by Zhong Lin Wang Springer Science+Business Media.

Membranes from ceramic nanofibers will provide an opportunity for membrane filtration in environments and processes where polymeric membranes are not suitable because of high temperature operation or because of the chemicals involved. In addition, membranes from ceramic nanofibers will be more resilient in long term use compared to sol-gel ceramic membranes.

Ceramic nanowire membranes made by the precepts of the present invention may be used as high temperature particulate filters, as in coal gasification processes. Coal gasification provides a means to convert coal into a variety of energy products. Coal gasification (a thermo-chemical process) breaks down coal into its basic chemical constituents by exposure to steam and carefully controlled amounts of air or oxygen under high temperatures and pressure to produce a mixture of carbon monoxide, hydrogen and other gaseous compounds. High temperature resistant filters are needed to remove impurities from the gas produced before it is used as fuel. Membranes of the present invention will have the high temperature resistance needed for this application, as well as high surface area due to their nanowire construction. Ceramic nanowire membranes may be used to fabricate battery separators for the electric vehicle market.

### SUMMARY OF THE INVENTION

The inventors disclose a ceramic nanowire membrane made of bonded ceramic nanowires. The ceramic membrane is bendable. The disclosed membranes have sufficient mechanical strength and sufficient chemical stability as well as filtration performance for commercial applications. Bonded ceramic membranes with a tensile strength of greater than 2.5 MPa and greater than 5.4 MPa are disclosed. The ceramic membranes may be made with a pore size of from about approximately 5 nm to about approximately 800 nm. The preparation of ceramic nanowires is realized through a hydrothermal treatment of a titanium-containing precursor, preferably titanium dioxide power or precipitate. Titanium dioxide nanostructures are preferred building materials.

The inventors also describe a method of making the ceramic membrane comprising bonded ceramic nanowires by in-situ formation of inorganic bonding materials in the presence of ceramic nanowire in a liquid carrier. The performed inorganic materials are inorganic precipitates from any known inorganic chemistry. The preferred bonding materials are silica, alumina, titania and zirconia. The paper fabrication procedure is followed to make bonded ceramic nanowire membranes.

The inventors also describe a method of making the ceramic membrane comprising bonded ceramic nanowires through post treatment of a weak ceramic membrane. The post treatment method include spray coating, spray infiltration and immersion. A complexing organic compound, such as acetylacetone, may be used to control the reaction during the post treatment process.

The inventors also describe a method of making the ceramic membrane comprising bonded ceramic nanowires through utilizing as made bonding within the nanowires formed during hydrothermal process.

The disclosed methods all lead to much stronger membranes with bonded ceramic nanowires.

### BRIEF DESCRIPTION OF FIGURES

FIG. 1A shows a simplified flow chart of the general membrane fabrication process.

FIG. 1B shows a simplified flow chart of the fabrication for bonded membranes by post-treatment.

FIG. 1C shows a simplified flow chart of the fabrication for bonded membranes by reaction of the membrane forming slurry.

FIG. 2 shows a small membrane making process.

FIG. 3 shows a continuous membrane making process.

FIG. 4A show shows an example of potassium titanate fiber agglomerates.

FIG. 4B show shows an example of sodium titanate fibers.

FIG. 5 shows a surface view SEM of a K-nanowire membrane.

FIG. 6 shows a surface view SEM of a Na-nanowire membrane.

FIG. 7 shows a bendable bonded ceramic nanowire membrane.

### DETAILED DESCRIPTION OF THE INVENTION

One dimensional (1D) nanostructures including nanotubes, nanowires, and nanofibers etc. have been the focus of academia and industry in the past two decades because of their unique physical and chemical properties. Nanowires are termed as one of such structures with a diameter in the range of about 5 nm to about 500 nm and a length of from tens to even hundreds of microns. Ceramic nanowires, due to their inherent superior properties are promising basic building blocks for novel products with unmatched characteristics. Titania nanowires were reported to be prepared by a simple hydrothermal treatment of titania precursor. Such a simple wet chemistry procedure allows the large-scale commercial use of titania nanowires.

Membranes made of fibrous materials are well known in membrane industry. Membranes made of nanowires allow pore size down to nanometer range that is hard to achieve by microfibers.

For practical applications, membranes for separations have to be physically robust and have the ability to be handled in order to be fabricated into useable and commercially effective products.

The problem faced by the present inventors was to form porous ceramic nanowires membranes with a sufficient mechanical strength, chemical stability and sufficient filtration performance. Membranes for commercial use must be strong and robust enough to withstand normal handling and mechanical forces imposed during manufacturing processes. These latter arise from transport of the membrane from one process step to another, forming or emplacement of the membrane into a filter holder or module and sealing. In addition, during use the membrane must remain integral. This means that the vibrations, pulses and temperature and/or pressure swings of the process cannot cause defects or ruptures to the membrane. There is also a need for membranes that can withstand temperatures and chemical environments for which present polymeric membranes are unsuitable.

To meet these requirements, the inventors have developed a family of robust membranes from ceramic nanowires.

A preferred manufacturing method for making a ceramic nanowire membrane comprises the steps of;
a. forming a dispersion of at least one nanowire material having a controlled amount of nanowire agglomerates in a liquid carrier,
b. forming a layer of the dispersion on a stationary or moving porous carrier,
c. removing the liquid carrier to form a membrane,
d. drying the membrane.

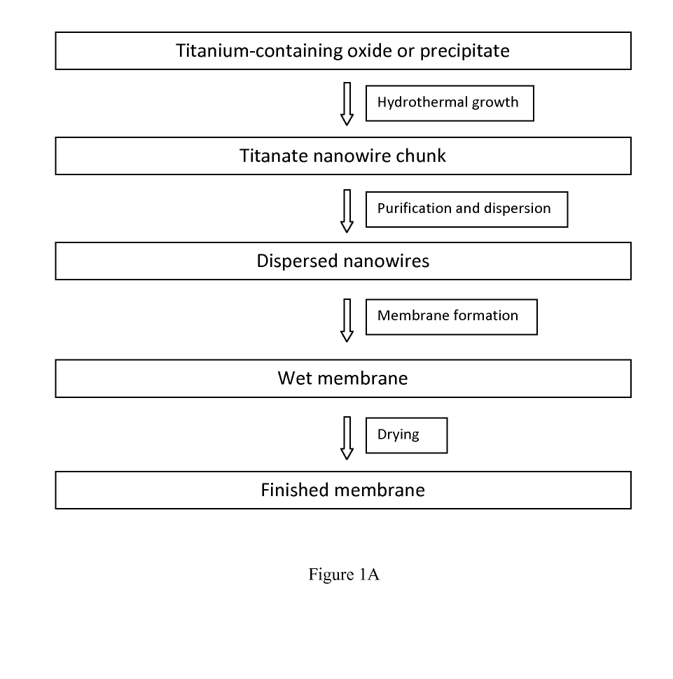

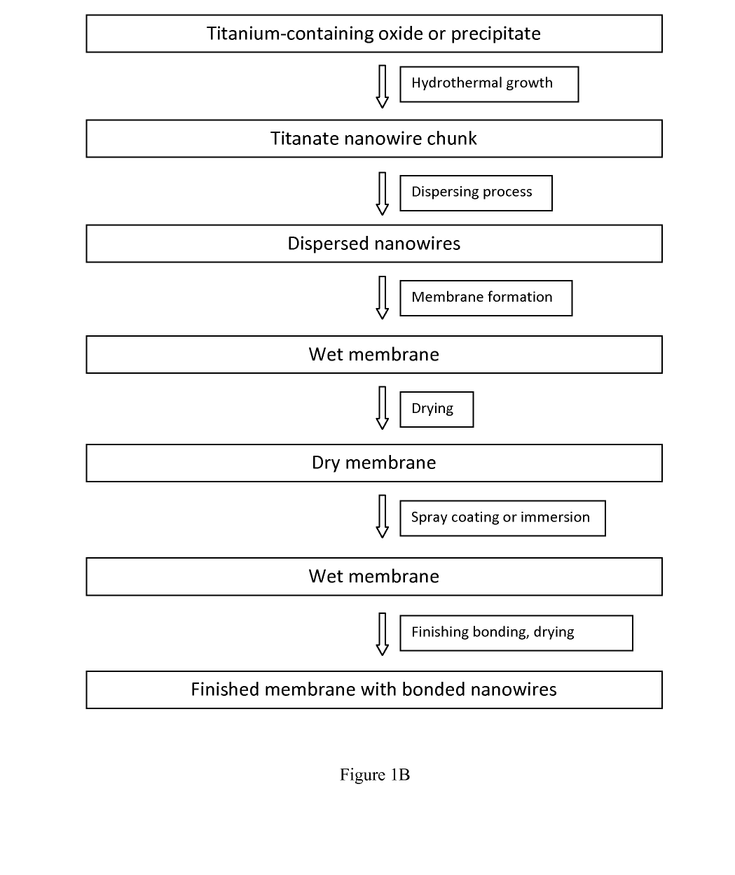

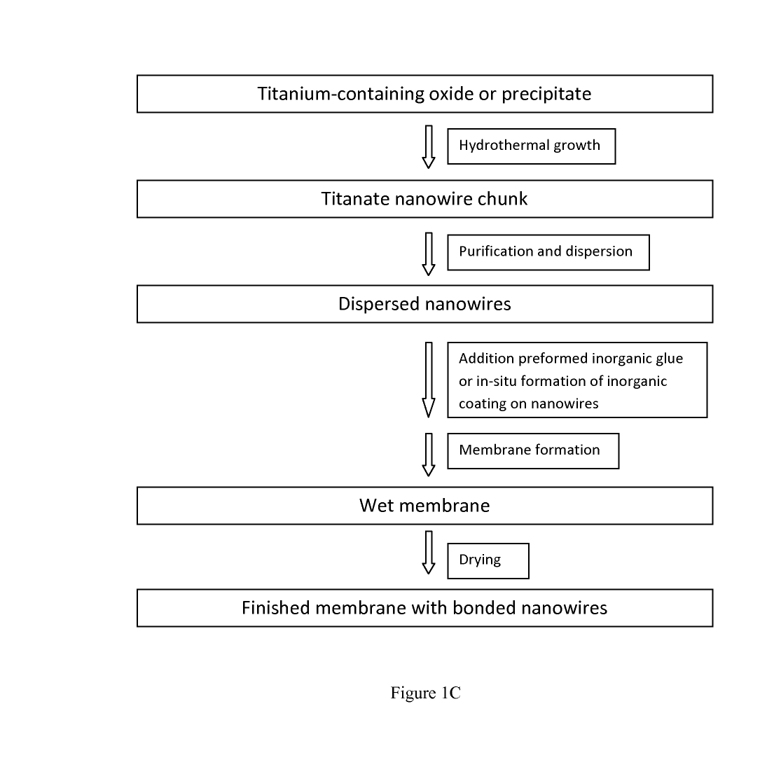

FIG. 1A illustrates the method of manufacturing that will be described in details below in the form of a flow chart.

The terms titanium dioxide, TiO₂, sodium titanate, potassium titanate, or hydrogen titanate, and titania are all used herein when describing nanowires or nanowire membranes to refer to nanowires or membranes made and formed from Ti-containing starting material. Sodium titanate nanowires (Na-nanowire or NaNW) and potassium titanate nanowires (K-nanowire or KNW) are used when the nanowires are made from sodium hydroxide and potassium hydroxide treatment, respectively, though the nanowires may not contain sodium ion or potassium ions in subsequent processing.

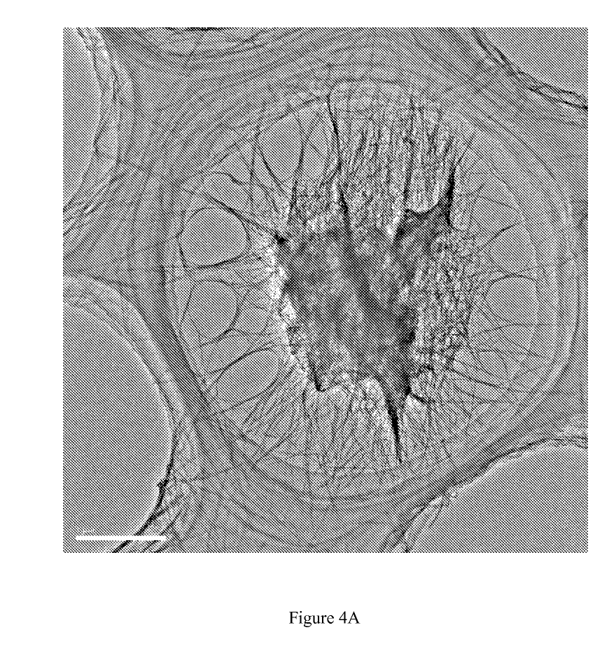

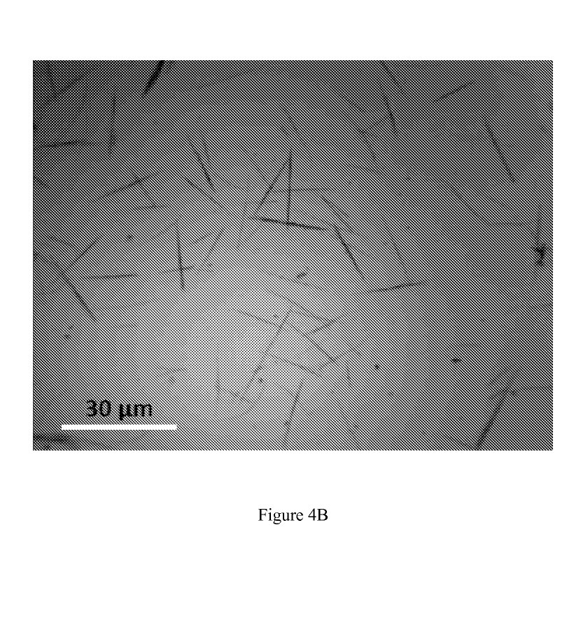

In the description provided herein the term agglomerate is used to define an entangled number of nanowires. The entangled nanowires may be multiple single nanowires or they may be multiple branched nanowires. An agglomerate may even be a single multiply branched entity. FIG. 4A shows an example of an agglomerate formed during a potassium hydroxide hydrothermal reaction.

The term bonded when referring to a bonded ceramic membrane is analogous to a crosslink in a crosslinked polymer. The examples of methods using a reactive bonding material described herein result in material being formed in the membrane that adheres to nanowires and spans the interstitial space between (usually) adjacent nanowires thereby joining or bonding them together.

The interstitial space of a membrane is the “empty” space between the structural component (here, nanowires) of the membrane. In other words, it is the porosity or the passageways of the membrane.

Porous membranes can be described by the dimension of their pores, or their pore size. The pore dimension may be measured by microscopic methods and an average diameter of the pores given. The retention of a membrane may be measured for a similar group of solutes or a group of particles having different sizes and the membranes, i.e. their pore size, given as the retention of the smallest solute/particle that is retained about a specified percentage. Other methods, such as the bubble point method used for microporous membranes are also available.

As used herein, ceramic membrane or ceramic membranes means that the membrane is entirely of a ceramic composition.

Titanium dioxide, TiO₂, is a preferred nanowire starting material and the nanowires (sometimes described as nanofibers) and membranes will be referred by titania, titanate or TiO₂.

Nanowire dispersions were made by first producing the nanowires and then making up a dispersion having a controlled amount of nanowire agglomerates to the desired concentration. The preferred method for making nanowires is the hydrothermal process. This method forms nanowires by crystallizing the material of interest in high temperature alkaline aqueous solutions at high pressures. A variety of materials, elements, oxides, carbonates, etc., have been synthesized by this method.

The hydrothermal nanowire production process comprises making a dispersion of a TiO₂ precursor in an alkali solution and raising the temperature to a desired level for a predetermined time. The precursor may be pigment-grade titanium oxide, which is usually a mixture of anatase and rutile forms, pure crystalline anatase, a TiO₂ gel made for example by hydrolysis of titanium isopropoxide or ethoxide, or other forms of solid TiO₂. TiO₂ may be from approximately about 1 to about 100 grams per liter, with a preferred range of concentrations of from about 5 to about 50 grams per liter, and a most preferred range of about 10 to about 30 grams per liter. The alkali solution may be made preferably using sodium hydroxide (NaOH) or potassium hydroxide (KOH). Lithium hydroxide, magnesium hydroxide, barium hydroxide, calcium hydroxide, strontium hydroxide, and cesium hydroxide are given as non-limiting examples of other bases that may be used to formulate the alkali solution. Alkali solutions of from about 4 moles per liter (M) to about 15 M may be used, with a preferred range being from about 5 M to about 10 M. In practice, the precursor/alkali solution dispersion is sealed in a polytetrafloroethylene (PTFE) lined pressure vessel and heated to temperatures of from about 180° C. to about 300° C. for times sufficient to allow the nanowires to form. Heating times of from about 6 hours to about a week may be used. Preferred times with NaOH and KOH are from about 6 hours to about 24 hours.

Examples 1, 3, 4, and 5 describe the basic method for making titania nanowires from solid and wet precursors. A wet precipitate preparation is described in Example 2 of the Examples.

Hydrothermal reactions were conducted using potassium hydroxide and sodium hydroxide. Example 1 and 3 describes making KNW, potassium hydroxide formed nanowires from titania nanopowder and wet precipitate, respectively. These nanowires had individual diameters of approximately 10 nanometers (nm) and were microscopically observed to be combined into nanowire agglomerates.

Examples 4 and 5 show NaNW (sodium hydroxide formed nanowires, or Na-nanowires) made from nanopowder and wet precipitate respectively. These nanowires had individual diameters of approximately 100 nm. The NaNW were seen to be primarily individual fibers. FIG. 4B shows optical image of NaNW nanowires taken from a slurry of the nanowires.

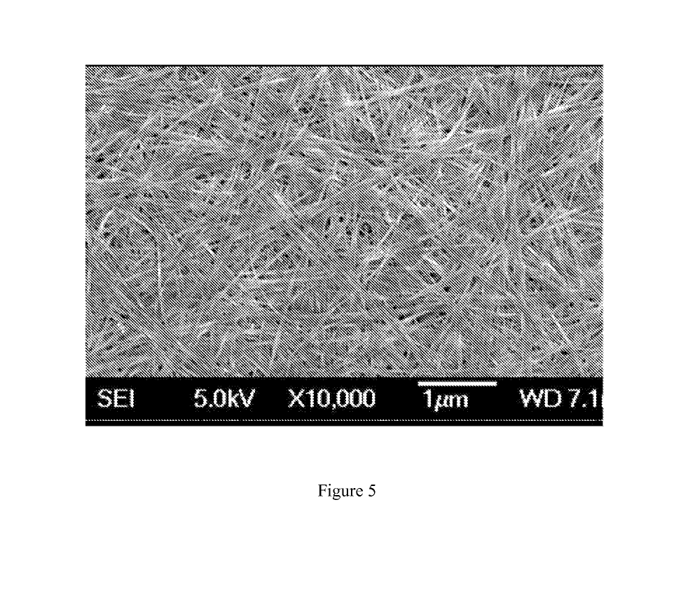

Nanowire preparation using KOH (K-nanowire) was carried out by adding titanium oxide precursor to 8 to 15M KOH at 110° to 240° C. for 6 to 24 hours. The final product was wax-like gel white in color. The K-nanowires and membranes made of K-nanowires were examined under TEM (transmission electron microscopy) and SEM (scanning electron microscopy). The typical diameter of K-nanowires was ˜10 nm and length about ˜10 microns. Some distinguishing characteristics of K-nanowires were their smaller diameters compared to Na-nanowires and an entangled or agglomerated morphology. The K-nanowires show linear agglomeration, that is, two or more fibers are attached to each other along their length-wise direction. FIG. 5 shows that K-nanowire membrane is made up of individual nanowires and linear nanowire agglomerates.

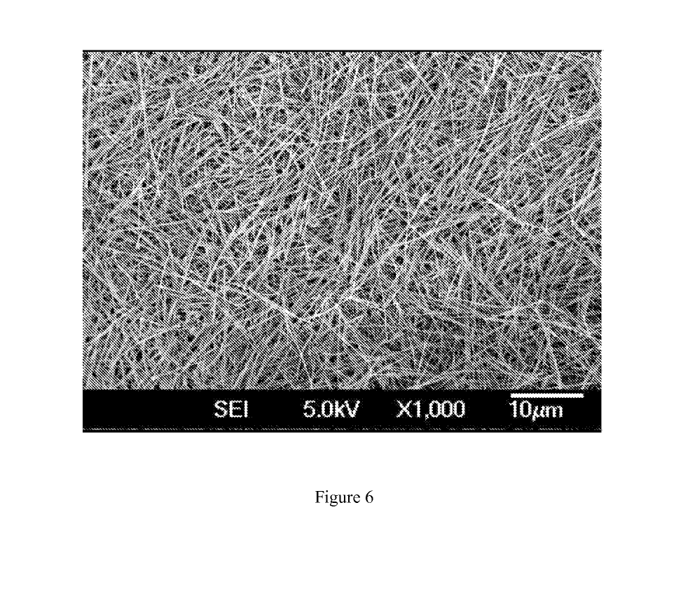

Na-nanowire preparation was similarly carried out by adding titanium oxide precursor to 8 to 15M NaOH at 110° to 240° C. for 6 to 24 hours. The final product was white precipitate of nanowires. Na-nanowires were distinguished by their larger diameter, longer length, and relatively straightforward morphology. The typical diameter of Na-nanowires was approximately 100 nm and the length from approximately 10 to approximately 50 μm. Less agglomeration was observed in Na-nanowires. FIG. 6 illustrates a surface view of a sodium titanate nanowire membrane.

The list below gives solid titania precursors and liquid chemicals used to make wet precipitates used in the course of these investigations. They are shown in order to illustrate some of the variations of precursor materials possible and are not meant to be limiting in any way.

Here is the list of titanium-containing precursors used for nanowire preparation.

### Solids

Titanium (IV) oxide, rutile, white powder, ˜1000 nm, Alfa Aesar
Titanium (IV) oxide, rutile, <100 nm, Sigma Aldrich
Titanium (IV) oxide, anatase, ˜25 nm, Sigma Aldrich
Titanium (IV) oxide, mixture of rutile and anatase, <100 nm, Sigma Aldrich
Ti-Pure® Titanium Dioxide Pigment—Plastics Grades R101, Dupont, Wilmington, Del.
Ti-Pure® Titanium Dioxide, R796+SA00, Dupont, Mexico
Titanium (IV)dioxide P25, ˜25 nm, mixture of anatase and rutile, Aeroxide, N.J.
Titanium Dioxide CR-834, ˜170 nm, Tronox, Oklahoma City, Okla.

Liquid Precursors Used for Wet Precipitate Formation
Titanium (IV) isopropoxide, VERTECÒTIPT, 97+%, Alfa Aesar
Titanium oxysulfate, 75˜85%, Sigma Aldrich
Titanium butoxide, 97%, Sigma Aldrich
Titanium chloride, 99.0%, Alfa Aesar

In the methods described herein, the hydrothermal reaction takes place without stirring. As a result, the formed nanowires precipitate and form a solid mass at the bottom or the autoclave. To be useful for membrane formation this mass has to be redistributed into a uniform dispersion. A standard blender (Oster; Jarden Consumer Solutions) was used to reduce the precipitated mass. It was found that control of the blending time was necessary to produce acceptable membranes. If not blended long enough too many large segments of the bulb were left and a weak and defect ladened membrane results. If blended too long, about 30 minutes or longer, microscopic examination reveals a broad particle size distribution that is believed to give too many small particles and poor membrane formation. A blending time of about 10 minutes was found optimal for these experiments. These times are not to be considered definitive, but only show that care must be taken to for dispersion production such that particle size and distribution are controlled to make an optimal membrane in terms of strength and few or preferably no defects. With other dispersion methods the experimenter will have to determine their optimum conditions.

Dispersion herein refers to fine particles distributed throughout a liquid medium. The dispersion medium or carrier is primarily aqueous, but in some cases may contain organic solvents or additives such as alcohols or other water soluble organic molecules that are easily removable and do not leave a residue. Dispersions are sometimes distinguished from suspensions based on size. The boundary is sometimes given as one micron; smaller particles comprise dispersions, larger, suspensions. Herein, dispersions, suspensions, or slurries will refer to nanowires distributed in a liquid medium.

The inventors carried out a series of initial experiments to develop ceramic nanowire membranes.

Laboratory vacuum filter holders were used for making 17 mm and 37 mm diameter membranes. The 37 mm membranes were used for filtration property evaluation and fabrication process optimization. A prepared volume of nanowire dispersion was poured into the filter holder having a glass fiber filter (4 micron to 8 micron filters were used in these experiments) and vacuum applied with a vacuum pump. Vacuums of about 200 mm Hg were suitable. A white sheet formed on the filter when dewatering was neatly completed and the sheet, i.e., membrane was easily removed. Membranes of from about 10 microns to about 300 microns thick could be made by this laboratory process. These membranes were used for filtration property evaluation and fabrication process optimization.

The membranes prepared via filtration were dried under a heat press at 40° C. to 120° C. for 5 to 30 minutes, and calcined at higher temperatures between 250° C. to 500° C. for 30 to 60 minutes. The dried membranes were observed of excellent bendability. Bendability refers to the ability of the membranes to be curled.

The inventors found after considerable trials that membranes with better properties (e.g., strength, permeability) resulted when the dispersion was not run for excessive times. That is, rather than attempting to attain a homogeneous dispersion of single fibers, the inventors found that producing a dispersion with a significant amount of nanofiber agglomerates produced a better membrane product. FIG. 4A shows a TEM of a typical K-nanowire agglomerate produced by controlled dispersion.

A dry sodium titanate nanowire membrane made according to Example 6 was immersed in tetrahydrofuran (THF) for six months with no swelling or other signs of physical change observed after that time. This shows that a nonaqueous solvent does not cause the nanowire disengagement and release seen in the case where sodium titanate nanowires are immersed in water and gently shaken in Example 6.

A dry sodium titanate nanowire membrane made according to Example 6 was calcined at 300°, 500°, and 700° C. in air for 1 hour. Flexibility was evaluated by bending the membrane sample into a U-shape. The membrane remained flexible after 300° and 500° C. calcination, but became rigid and inflexible after 700° C. calcination. The high temperature calcination does not improve the mechanical strength of these membranes in a meaningful way.

Further work resulted in an improved method of redispersion by the use of a three roll mill. The white bulb described in Example 1 (potassium titanate nanowires) was manually stirred into 20 ml of a saturated sugar solution until a white paste was formed. The bulb as made contains about 90% liquid. The paste was then processed in a three roll mill (Lab Model, Torrey Hills Technology, San Diego Calif.) with a gap set at 30 microns. The paste was processed three times at the preset roll speed of the three roll mill.

The gap was set at a distance that would not break the fibers by being too narrow, yet would exert enough force to reduce the large agglomerates in the starting paste to a paste with a relatively uniform agglomerate size. Sugar was used as an economic and easy to remove additive. Other additives that form a workable paste and are economical, easy to dissolve and to remove after processing and do not leave a residue on the nanowires will be suitable.

After sugar removal from the final paste by filtering and washing with water, the resulting nanowire dispersion was found to be made up of nanowires clusters or agglomerates of about 10-20 microns particle size. The use of the sugar solution resulted in better nanowire redispersion and subsequent membrane formation than when only a water dispersion was used. It is believed that this process provides for a higher shear being applied to the nanofiber agglomerates due to the higher viscosity and less physical contact between the mechanical parts of the mixing equipment resulting in less nanowire damage.

The alkaline nanowire dispersion may be partially or fully neutralized with acid, or may be filtered and washed, or washed in a settling tank with clear fluid overflow. Other methods are available to those skilled in the art of solid-liquid separations. The purpose of these types of process steps is to produce an alkaline free nanowire dispersion for membrane manufacture. An alkaline free dispersion would be useful in a continuous process in that it would reduce or eliminate washing of the formed membrane before a drying step. The dispersion may be modified by changing the pH or by adding salts in order to beneficially affect the ion interactions of the nanowires in the dispersion and the resulting membrane formation as described in the following.

There is an interaction between nanowire structure and the resulting membrane. The length of the nanowires or more precisely the ability to form an intertangled mesh or network will play a key role in membrane strength and robustness. The diameter of the nanowire will affect the pore size of the membrane and the surface area available for contact (i.e. ad- or absorption). Smaller diameter nanowires will have smaller pores and higher surface area. The differences between K-nanowires and Na-nanowires provide a means of varying membrane pore size as blends of K- and Na-nanowires would give pore size intermediate between the K- and Na-nanowire pore size. The pore size of the ceramic nanowire membrane can be affected by the conditions of formation. The rate of filtration will affect the compactness of the membrane formed; faster filtration will result in a more compact membrane with smaller apparent pore size. A slower filtration step will give a more open structure with a larger apparent pore size. Other means of producing nanowire membranes with different pore sizes or different apparent pore sizes are to compress the formed membrane, either in the wet of dry state, as by for example, by passing between calendar rolls. In Example 9 is demonstrated that a larger fiber may be added to the formulation of used to produce a ceramic membrane.

With these methods membranes with pore size from about 5 nm to about 100 nm, from about 25 nm to about 150 nm, from about 50 nm to about 250 nm, from about 100 nm to about 500 nm, and from about 300 nm to about 1000 nm may be made.

FIG. 1A shows a flow chart of the nanowire making process. The precursor of choice is stirred into an alkaline solution to form the slurry that will undergo the hydrothermal reaction. The slurry is sealed and heated for a desired time. The nanowire precipitate is cooled and removed. It is then dispersed in a controlled manner. The dispersion is layered on a porous substrate and dewatering commences. In practice layering and dewatering may occur simultaneously if the substrate is porous enough to allow flow by gravity. Dewatering is used as a general term for removal of the carrier liquid of the slurry since water is convenient and inexpensive. However, if other liquid carriers are used the process is the same. Once dewatered, the wet or air-dried membrane is dried with heat. Drying may be done, as non-limiting examples, in an oven, by convective air, infra-red radiation or a heated press or roll.

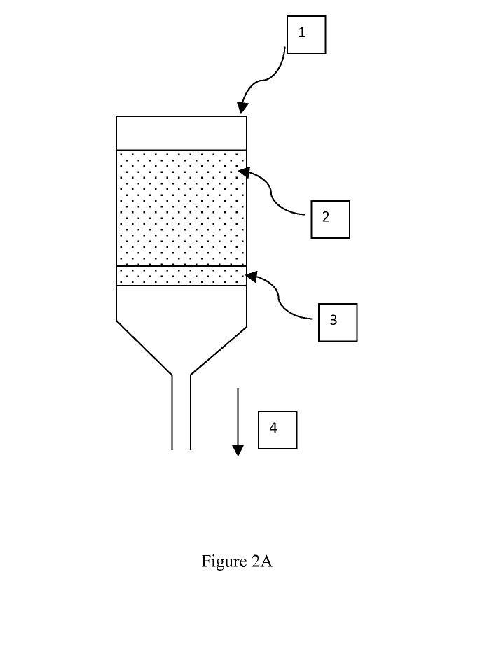

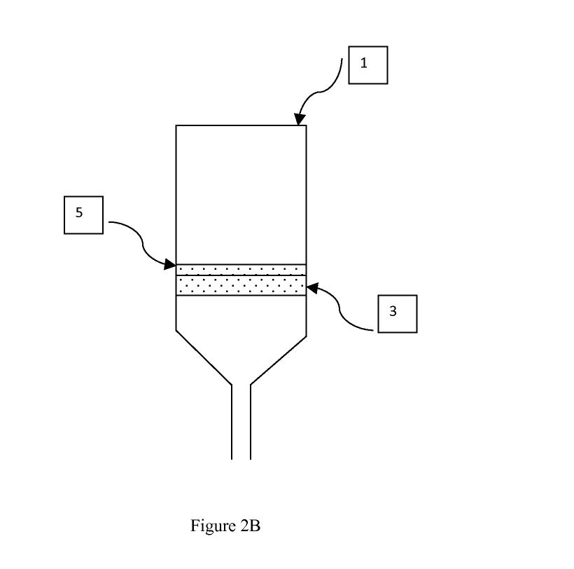

To form a membrane a practitioner will prepare a layer of dispersion containing a desired amount of nanowires, and remove the carrier liquid to concentrate the nanowires to a desired thickness. For aqueous dispersions, this is termed dewatering, which shall be used herein as a general term to mean all liquid removal processes practiced to form a nanowire membrane. Dewatering may be done by applying a layer of the nanowire dispersion on a porous substrate having pores of sizes small enough to retain the nanowires and allowing the dispersion liquid to pass through. The driving force for liquid passage may be gravity, vacuum applied on the substrate side opposite the side that the layer was applied to, or pressure may be applied to the layer. Combinations of these methods may be used. FIG. 2A illustrates a substrate in a filter holder with an applied dispersion layer. The filter holder is usually a funnel (1) with a permanently placed filter or porous support for a removable porous substrate (3). The dispersion (2) is loaded into the filter holder and the driving force is applied. A cover with a gas inlet may be sealed on the top of the filter holder and pressure applied to force water or other dispersion liquid through the porous substrate. Or a vacuum source may be attached to the outlet (4) to remove the liquid. The result will be to form the pre-membrane (5) on the substrate as illustrated in FIG. 2B. Those skilled in the arts of making porous materials such as paper filters or non-woven fabrics will recognize that this basic process can be scaled to a continuous manufacturing process using known machines and processes.

The substrate may comprise a metal or polymer wire screen, a porous membrane, a non-woven or woven fabric, or a felted fabric, or the like. The substrate should not allow a significant amount of nanowires to pass through, while being as permeable as possible to carrier liquid flow. In cases where the membrane is to be removed from the substrate to form a free-standing membrane, it is preferable that the surface whereon the dispersion is layered to be smooth to minimize adhesion of the membrane. If the membrane is to be a supported membrane, the substrate surface may be roughened to improve membrane-substrate adhesion.

A practitioner will control nanowire concentration in the dispersion and thickness of the liquid dispersion layer to be dewatered to obtain the desired membrane thickness. The rate and method of dewatering will play a role in determining final thickness. In addition, these variables will play important roles in determining membrane porosity and pore size and a skilled practitioner will by routine experimentation be able to manipulate the process variables described to achieve the membrane properties.

A practitioner may choose to control membrane thickness by empirically determining the relation between nanowire concentration in the liquid dispersion and resultant membrane thickness for a set volume of dispersion over a given filter area. A higher concentration will give a thicker membrane. By varying the volume of the dispersion on the substrate, a practitioner may achieve varying membrane thickness. For a batch process, such as a small scale laboratory experiment, a container such as a vacuum filter holder with a porous substrate placed in the container bottom provides large depth for the dispersion to be placed on the substrate.

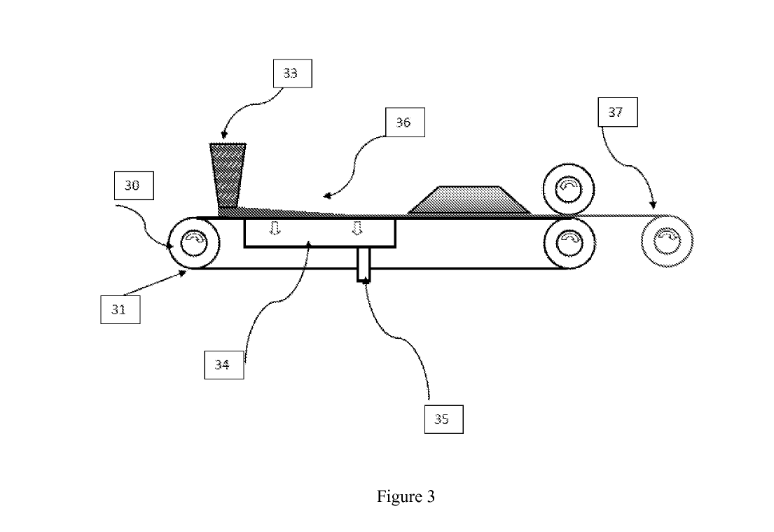

However, for a continuous or semi-continuous process where the dispersion is applied to a moving substrate web, control of the dispersion thickness depends on the application method for layering the dispersion, speed of the substrate web, and viscosity of the dispersion. FIG. 3 shows a simplified drawing of a continuous process. In FIG. 3, a continuous belt (31) is transported by two rolls (30) and passes under a dispersion applicator. As shown in FIG. 3, the applicator is a knife (33), as known in the coating arts, which spreads and applies from a dispersion (32) supplied continuously at a suitable volumetric rate a uniform coating on the web (36). The thickness is controlled by the viscosity of the dispersion, the speed of the web and the gap or distance between the web and the knife edge. Other application methods may be used. As examples, but not to be limiting to these methods, extrusion, slot coating or curtain coating may be used. When thin layers or coatings are required, transfer or gravure coating methods may be applicable. Such processes are described in “Coating and Laminating Machines” by H. L. Weiss published by Converting Technology Co., Milwaukee, Wis. (1977), or in “Microfiltration and Ultrafiltration Principles and Practice” Leos J. Zeman and Andrew L. Zydney; Marcel Dekker (1996) the teachings of which are hereby incorporated by reference.

The coated web passes over a vacuum box (34) that is kept at a controlled vacuum, by means of a vacuum pump or aspiration device, or like. The vacuum is supplied as for example as shown by (35), through a port that is connected to the vacuum pump or like device and which is the water or other liquid removal port. The vacuum box serves to significantly dewater the dispersion on the web. In the process shown in FIG. 3, partially dried or dewatered web (37) is released from the web and is further processed. If a supported membrane were desired, the porous web would be unrolled from a feed roll positioned before the coating apparatus, pass under the coating apparatus and over the vacuum box, and then on to further processing as part of dewatered web (37).

In an alternative process, the coated web may be passed through a convective or radiant oven to dry the dispersion down to desired dryness, or a combination of vacuum and heating may also be used.

Further processing to the web (37), whether a free standing or a supported membrane, will be determined by the required properties of the membrane being produced. The membrane may be further dried by direct convective or radiant heating or by passage over rolls with absorbent cloth, or over heated rolls. The web may be passed between rolls to compress the membrane in order to control porosity, strength, pore size, or some combination of these properties or other properties.

Since viscosity is an important property in terms of controlling coating, the dispersion may be modified by a viscosity enhancer. This may be a polymer, such as a high molecular weight water soluble polymer, although these may be difficult to completely remove, and organic materials such as sugars.

Example 6 describes a membrane made using NaNW. The membrane as made was coherent and had a tensile strength of 0.26 MPa. However, this membrane dispersed when immersed in water and gently shaken. Example 7 gives the production of a KNW membrane. This membrane does not disperse in water and has a high tensile strength of 11.5 MPA. The agglomerated structure of the nanowires is what differentiates these nanowires from the NaNW and may be the reason for the improved strength and resistance to dispersion in water.

The manufacturing process is very flexible as shown by Examples 9 and 10. In Example 9 glass fibers are added to the membrane forming slurry. The membrane is made in the same manner as described in Example 6. The membrane so made has higher tensile strength. In Example 10a supported membrane is made by forming a KNW membrane on a pre-formed glass fiber membrane. In this way a thinner yet integral KNW membrane can be formed which will take advantage of the higher flux that results from a thinner membrane and relies on the substrate for strength.

There is also a need for greatly reducing or eliminating nanowire loss during use of nanowire membranes. In some applications, loss of nanowires to the environment may pose health problems. Researchers probing the health effects of nanomaterials have not reached conclusive findings, but have reported that nanomaterials are deposited in the lungs more than larger respirable particles. Animal studies indicate that nanomaterials may enter the bloodstream from the lungs and translocate to other organs. The National Nanotechnology Initiative and NIOSH are among the governmental groups supporting studies on the effects of nanomaterials and means to mediate worker exposure.

Nanowire loss may result in weakening of the filter structure and shortened effective life or increase of the effective pore size and reduced filtration retention capability. The inventors have found methods of chemically binding together the nanowires of the membranes described herein without deleterious effects to their separating properties to meet this need.

The ability of a fibrous mat to retain its component fibers is dependent on several factors. If the fibers are long and sufficiently intertangled, then considerable force is required to remove the fibers. Even in this case, fibers at or near the surface of the mat are more easily disengaged because there is less interfiber contact. If there are fiber-fiber interactions such as covalent, hydrophobic or ionic bonds, then the ability of fibers to become disengaged will be reduced.

For the ceramic nanowire membranes described herein, the inventors have found in the case of sodium titanate based membranes that the individual nanowires do not adhere together when wetted with water. This is not surprising although not mentioned in the literature. Since the titania nanowires are very hydrophilic, a layer of water will wet each nanowire surface and between nanofibers, allowing disentanglement and release. The cluster structure of the potassium nanowires may be the reason that membranes made from these do not show evident disentanglement. However, individual potassium nanowires may be released.

One reason for bonding the nanowires together is to prevent the nanowires from disentangling and being spread into the environment. As well this will weaken the membrane and may make it unusable. The inventors have found that using bonding techniques as described in Examples 8, 11, 12, 13, 14, and 15 that they are able to significantly increase tensile strength of the membranes. In the case where more than one layer of nanowire membranes are formed as in Example 8, the bonding technique helps to bind the layers together. This effect will be useful when layers of different materials are used.

A preferred bonding material is titanium isopropoxide. Titanium isopropoxide, Ti(OCH(CH₃)₂)₄ is used to synthesis of TiO₂-based materials. Typically water is added to a solution of the alkoxide in an alcohol. The inorganic product that results in is a function of additives (e.g. acetic acid), the amount of water, and the rate of mixing.

Complexing agents, such as for example, acetylacetone, acetic acid, propionoic acid, acetone, citric acid may replace some of OCH(CH₃)₂ in the original compound and influence hydrolysis rate.

Higher temperature calcination, 300° C. to 500° C. will convert titanium hydroxide to titanium oxide and thus finish inorganic bonding.

Other inorganic reactants capable of reacting with the oxide or hydroxyl groups on nanowire surfaces may be used. Examples are; Titanium(IV) propoxide, Titanium(IV) butoxide, Titanium(IV) methoxide, Titanium diisopropoxide bis(acetylacetonate), Titanium(IV) 2-ethylhexyloxide, Titanium(IV) oxyacetylacetonate, Titanium(IV) tert-butoxide, TiCl₄, Titanium(IV) bromide, TiO(SO₄).

Non-titanium containing inorganic reactants that may be used are; Waterglass (Na₂O.xSiO₂), Silicon tetraacetate, SiCl₄, Methyltrichlorosilane, Ethyltrichlorosilane,

Tetraethyl orthosilicate (TEOS), NaAlO₂, Al(i-OC₃H₇)₃, Al (NO₃)₃, Al₂(SO₄)₃, AlCl₃, Aluminum acetylacetonate, Aluminum tributoxide, Aluminum ethoxide, Aluminum-tri-sec-butoxide, Aluminum trimethoxide, ZrOCl₂, Zirconium acetate, Zirconium(IV) acetylacetonate, Zirconium(IV) butoxide, Zirconium(IV) ethoxide, Zirconium(IV) isopropoxide, Zirconium(IV) oxynitrate hydrate, Zirconium(IV) propoxide, Zirconium(IV) sulfate, Zirconium(IV) tert-butoxide.

The chemicals discussed are termed reactive bonding materials. They form a chain or multiple chains of reaction products, in essence inorganic polymers which join or bond individual nanowires together to form a bonded membrane. These bonds contain links comprised of the metal used. For example, when titanium isopropoxide is used there will be titanium-oxygen links. Similarly silicone-oxygen, aluminum-oxygen and zirconium-oxygen links are the backbone of bonding materials resulting from reactive bonding materials based on silicon, aluminum and zirconium.

A general procedure will be described using titanium isopropoxide, but workers skilled in the art of surface modification will recognize that other chemicals, such as mentioned above may be used in similar manner. A dry membrane is immersed or otherwise contacted, such as by spraying with a solution of titanium isopropoxide. Acetylacetone is added as a complexing agent to the solution in order to reduce the rate of hydrolysis of the isopropoxide. Other non-limiting examples of complexing agents are organic acetates, acetone and organic acids. This use of alcohols as a solvent is preferred, anhydrous ethanol being more preferred. Non-limiting examples of other solvents are isopropanol, butanol, THF, acetone, diethyl ethers, or lower molecular weight esters. Solvents used should be anhydrous.

The procedure described may be done in a dry atmosphere without the complexing agent, for example in a glove box under a dry atmosphere, or in a manufacturing facility with controlled humidity. The titanium isopropoxide concentration may be from about 5% to about 45% (w/w) of the solution, more preferably from about 10% to about 30%. The amount or titanium isopropoxide is determined by the need to obtain a coverage of the final bonding material on the nanowires making up the membrane sufficient to bridge adjacent nanowires, yet not be an excessive amount to a point of blinding the pores of the membrane. The complexing agent is usually added on an approximately equi-molar basis with the isopropoxide or other bonding chemical. The membrane may be contacted with the treatment solution in a variety of ways as discussed below. The initial contact is usually for a short time just enough to wet the nanowires. The wetted membrane is then dried to concentrate the bonding chemical on the nanowires surface and or nanowire junctions. A moderate temperature of about 40° C. to about 85° C. is satisfactory. The dried treated membrane is then held in an oven with a high water vapor concentration to cause hydrolysis of the isopropoxide and internanowire bonding. The temperature may be from about 80° C. to about 180° C., preferably about 100° C. to 160° C. The water vapor can be generated for example, by vaporization from a liquid water containing open vessel held in the oven or by adding steam or a water vapor gas stream to the oven. The reacted membrane is then given a final drying. An optional calcining step at from about 300° C. to about 500° C. may be used to finish the reaction.

The membranes described herein are held together by a combination of physically intermeshed nanowires and intermolecular forces between fibers. In some cases, the inventors have found that the membranes will disentangle when immersed in water and gently shaken. The problem of small amounts of nanofiber emission also led the inventors to develop membranes in which the nanofibers are bonded together. The inventors realized that an organic or organic containing binder would be damaged by any UV light exposure, since it is well known that TiO₂ decomposes organic material on its surface when exposed to UV light.

Therefore a method of contacting the membrane with a solution of reactants that would result in an all-ceramic binder holding the nanowires together was developed. The contacting mechanism could be either immersion of the membrane into the solution or by controlled spraying of the solution onto one or both surfaces on the membrane.

In the immersion method, a uniformly treated membrane was produced. This method is useful when the membrane will be supported and not be required to be very bendable. Examples of this type of product are laboratory disk membranes or membranes sealed in a holder and then treated.

FIG. 1B shows a simplified flow chart of a post treatment method for making a bonded ceramic nanowire membrane. The membrane, usually dried, is wetted with a solution containing the reactants. This is discussed in more detail in the Experiments section. The solvent is then removed, usually be evaporation, resulting in the nanowires becoming coated with the reactants. The reactants are then cause to react. In the case where a metal eater is used, water vapor is added to initiate the reaction. The membrane is then heated and dried and optionally calcined as needed to finalize the bonding.

If the membrane is supported on a substrate one side may be spray treated so that the nanowires near the surface are relatively strongly bonded and the inner nanofibers are less bonded. This asymmetric treatment will reduce any permeation loss due to the treatment and maintain a higher level of bendability for the membrane. This procedure may be done with a vacuum applied on the opposite side to that being wetted. This method may draw the sprayed solution somewhat deeper into the membrane depth.

For a free standing membrane both sides may be spray treated in order to seal the membrane surfaces from nanowire loss while maintaining a high percentage or all of the original permeation and bendability.

NaNW membranes were treated by the method described. Example 8 shows how a two layer membrane may be treated by passing a solution of titanium isopropoxide through a membrane and completing the bonding reaction with heat and water vapor. In Example 11 a dry membrane is immersed in a reaction solution, dried and then the reaction is initiated and completed by heat and water vapor. Example 12 is a case where a spray method is used to apply the reaction solution. In all these Examples the final membrane retained its filtration properties and showed increased strength and showed no effect when immersed in water.

The nanowires may be bonded by other treatment methods. The bonding chemistry may be added to the nanowire slurry prior to membrane fabrication so that a reactive coating is formed on the nanowire surface. Post membrane formation reaction will cause bonding to occur. This is demonstrated in Example 14 where sodium aluminate is added to the membrane forming slurry, and then in-situ coating or precipitate happens after neutralization of the slurry. After membrane formation and drying a heat treatment at 300° C. bonds the nanowires and the membrane is not dispersed when immersed in water. FIG. 1C shows a simplified flow chart of this method. To a nanowire slurry is added the reactants needed to form a bonding precipitate or coating. Slurry conditions are changed to cause the precipitation or coating. The treated nanowire slurry is now formed into a membrane and heated and dried. This will bond the nanowires and from a bonded nanowire membrane. Further calcining may be done to finalize the bonding as needed. The bonding materials can also be added as preformed inorganic sol, such as colloidal silica. A sol is a colloidal suspension of very small solid particles in a continuous liquid medium.

The chemicals discussed are termed reactive bonding materials. They form a chain or multiple chains of reaction products, in essence inorganic polymers that join or bond individual nanowires together to form a bonded membrane. These bonds contain links comprised of the metal used. For example, when titanium isopropoxide is used there will be titanium-oxygen links. Similarly silicone-oxygen, aluminum-oxygen and zirconium-oxygen links are the backbone of bonding materials resulting from reactive bonding materials based on silicon, aluminum and zirconium.

Example 13 shows the results from a KOH hydrothermal treatment of a NaNW membrane. This treatment reduces its sensitivity to water.

Table 1 below shows a summary of some properties of the membranes made during this work. Porosities for bonded membranes remain at greater than 70%. Pore size, as rated by bead retention, range from at least about 53 nm to about 500 nm. This range is not the limits of possible membranes, but only reflects the membranes made to date.

TABLE 1
Enhanced mechanical property via internanowire
bonding and entanglement.

| | | | Bead size | |
|---|---|---|---|---|
| Example # | Nanowire used | Porosity | retained | Tensile strength |
| 6 (unbonded) | NaNW | 90.9% | 480 nm | 0.26 MPa |
| 7 (bonded) | KNW | 73.2% | 53 nm | 11.5 MPa |
| 10 (bonded) | KNW/ | — | 53 nm | — |
| | Glassfiber | | | |
| 11 (bonded) | NaNW | 81.8% | 480 nm | 2.5 MPa |
| 14 (bonded) | NaNW | 80.8% | 480 nm | 5.4 MPa |

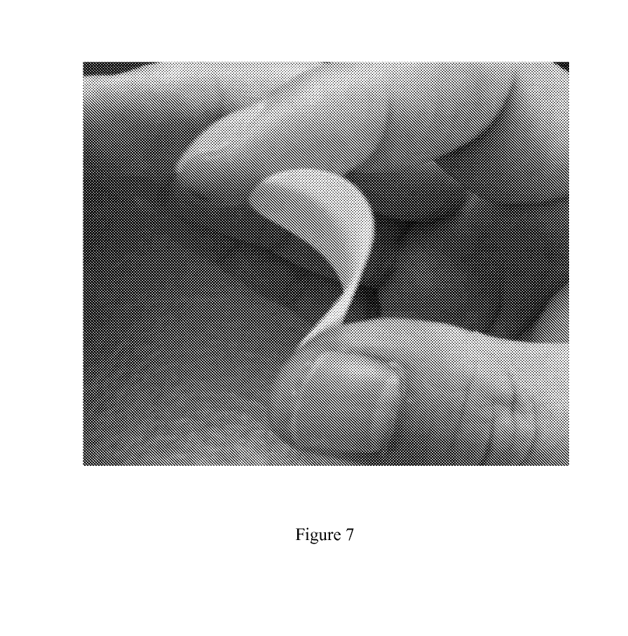

The ceramic nanowire membranes, both as made and when treated to make a bonded membrane, are bendable. This means that the membrane can be bent to an angle beyond the initial plane of the membrane without breaking FIG. 7 shows a bonded membrane held at approximately 45 degrees. The Bendability Test is a simple test to give a semi-quantitative rating to a membrane. The diameter of the tube which a membrane can be bent around; smaller equals more bendable; is a rating used to define bendability.

Practitioners skilled in membrane or filter development will realize that that the membrane manufacturing methods described can be adapted without undue experimentation to produce membranes having a broader range of sizes, thicknesses and filtration properties.

The following examples illustrate the present invention and are not intended to limit the same. A practitioner of ordinary skill in the art of developing and producing porous polymer structures, particularly porous membranes, will be able to discern the advantages of the present invention. It is not the intent of the discussion of the embodiments of the present invention to exhaustively present all combinations, substitutions or modifications that are possible, but to present representative methods for the edification of the skilled practitioner. Representative examples have been given to demonstrate reduction to practice and are not to be taken as limiting the scope of the present invention. The inventor seeks to cover the broadest aspects of the invention in the broadest manner known at the time the claims were made.

### Test Procedures

### Flux Evaluation

A membrane is mounted on a 25 mm vacuum filter holder system. 10 ml of DI water is added into the filter top holder. A vacuum is then applied and the filtration to empty the top volume time is recorded.

### Filtration Performance Evaluation

A membrane sample is mounted on a 25 mm filter system. A solution of dyed polymeric beads with certain size is poured onto the membrane. A vacuum is then applied and the effluent color compared with a set of standards made up of serially diluted solutions.

### Solvent Stability Evaluation

Solvent stability evaluation: A nanowire membrane is immersed in a solvent for certain time. The membrane integration is evaluated with optical microscopes, and flexibility is tested by Bendability Test.

High temperature stability test: A dry membrane was calcined at elevated temperature in air for 1 hour.

### Bendability Test

An in-house rolling test apparatus is used to evaluate membrane flexibility or bendability. The rolling test apparatus is made of a PVC tube. Several outer diameters, from one to four inches and a length of one foot are used. A porous Teflon-coated sheet with a width of 1 foot and a length of 2 feet is glued along an axial line on the outer wall of the PVC tube. The rolling test is done by placing a nanowire membrane on the Teflon-coated sheet and rolling the Teflon sheet up on the PVC tube. If the membrane remains undamaged after rolling, it is deemed bendable the rolling test for that diameter.

### Tensile Strength Evaluation

A house made tensile test apparatus is used for tensile strength test. A spring scale (250 g with 2 g scale or 500 g with 5 g scale) is used. In a typical in house tensile strength test, a membrane is cut to a rectangle of 1.5 cm by 0.5 cm. The membrane to be tested is mounted between two pieces of copy paper (2 cm by 1 cm) using scotch tape with the membrane sample in the middle. One piece of copy paper is mounted on the spring scale with a punched hole and the other piece is pulled by hand, and the scale reading read at break.

### Experimental Examples

1. Formation of Potassium Titanate Nanowires from Titania Nanopowder

To one liter of a 10M potassium hydroxide (KOH) solution in a two liter polytetrafloroethylene (PTFE) lined stainless steel pressure vessel was added 45 grams of titania nanopowder (Aeroxide® P25, Acros, Pittsburgh Pa.). The mixture was stirred and the resulting slurry was mixed thoroughly. The pressure vessel was sealed and out into a convective oven (MTI Corp. CA) at 230° C. for 24 hours. A whitish gelatinous bulb was formed. Transmission electron microscopy (TEM) showed nanowire structures with diameters of about 10 nm and an interlinked macrostructure with multiple nanowires connected to form clusters or agglomerates.

### 2. Preparation of Titanium-Containing Wet Precipitate

In a 1 L beaker 200 ml titanium isopropoxide (Alfa) was added dropwise to a solution of 400 ml ethanol (Alfa) and 40 ml DI water with vigorous stirring. After complete addition the slurry was stirred for another hour. The white slurry was then filtered and washed with DI water. The wet cake was used for nanowire growth with no drying and no calcination.

3. Formation of Potassium Titanate Nanowires from Wet Precipitate

To one liter of a 10M potassium hydroxide (KOH) solution in a two liter polytetrafloroethylene (PTFE) lined stainless steel pressure vessel was added 45 grams (dry weight) of titanium-containing wet precipitate. The mixture was stirred and the resulting slurry was mixed thoroughly. The pressure vessel was sealed and placed into a convective oven (MTI Corp. CA) at 230° C. for 24 hours. A whitish gelatinous bulb was formed. Transmission electron microscopy (TEM) showed nanowire structures with diameters of about 10 nm and an interlinked macrostructure with multiple nanowires connected to form clusters or agglomerates. The membrane was held in 90° C. water for three hours and retained its shape and integrity.

4. Formation of Sodium Titanate Nanowires from Titania Nanopowder

In a similar manner to Example 1; to one liter of a 10M sodium hydroxide (NaOH) solution in a two liter PTFE lined stainless steel pressure vessel was added 45 grams of titania nanopowder (Aeroxide® P25; Acros, Pittsburgh Pa.). The mixture was stirred and the resulting slurry was mixed thoroughly. The pressure vessel was sealed and out into a convective oven (MTI Corp. CA) at 230° C. for 24 hours. In this case a white precipitate was formed. Transmission electron microscopy (TEM) showed discrete nanowire structures with diameters of about 100 nm and nanowire lengths of approximately 10 micron.

5. Formation of Sodium Titanate Nanowires from Wet Precipitate

In a similar manner to Example 3, to one liter of a 10 M sodium hydroxide (NaOH) solution in a two liter PTFE lined stainless steel pressure vessel was added 45 g (dry weight) of titanium-containing wet precipitate. The mixture was stirred and the resulting slurry was mixed thoroughly. The pressure vessel was sealed and out into a convective oven (MTI Corp. CA) at 230° C. for 24 hours. In this case a white precipitate was formed. Transmission electron microscopy (TEM) showed these nanowires have a diameter of about 100 and a length of 10 to 30 micron. Optical microscopy showed the discrete feature of these sodium titanate nanowires.

### 6. Preparation of Sodium Titanate Nanowire Membrane

Wet fibers of acidified sodium titanate nanowires redispersed from a solid precipitate using the three roll method (0.05 grams dry fiber) was added to 25 ml of DI water and vigorously stirred to form a slurry. The slurry was filtered using a 47 mm glass frit filter with a nonwoven polypropylene overlay at 20 inch vacuum. A white membrane, about 125 microns thick was formed and dried in a heat press at 80° C. for 15 minutes. The nanowire membrane was then removed from the polypropylene substrate. Membrane porosity was about 90%. The free standing membrane was bendable even after calcination in air at 500° C. for one hour. A tensile strength of 0.26 MPa was measured using a manual spring scale as described in the Methods Section. The freestanding membrane was immersed in room temperature water and was observed to fall apart (disperse) upon gentle shaking (See, for example, Example 1 of the PCT Application of Publication Number WO 2008/060309A2.)

### 7. Preparation of Potassium Nanowire Membrane

Potassium titanate nanowires (0.048 grams dry nanowires) dispersed by using the three roll method was added to 25 ml of DI water and vigorously stirred to form a slurry. The slurry was filtered using a 47 mm glass frit filter with a nonwoven polypropylene overlay at 20 inch vacuum. A white membrane, about 45 micron thick was formed and dried in a heat press at 80° C. for 15 minutes. The nanowire membrane was then removed from the polypropylene substrate. The free standing membrane was bendable enough to pass one inch rolling test. A tensile strength of 11.5 MPa was measured as described in the Methods Section. A porosity of 73.2% and a flux of 99.7 L/m²/h at 0.8 bar TMP was measured. The membrane does not fall apart in water after gentle shaking It retains 53 nm dyed beads with high efficiency.

### 8. Preparation of a Bonded Two Layer Composite Membrane

A nanowire membrane was made from sodium titanate nanowires as described in Example 6. While still a wet protomembrane on the polypropylene substrate another slurry this time of potassium titanate nanowires was poured on the wet sodium membrane and vacuum applied. The weight ratio of sodium titanate nanowires to potassium titanate nanowires used was 8 to 1 A two layer membrane of a thin potassium titanate nanowire layer on top of a thicker sodium titanate nanowire layer was thereby formed. The wet composite membrane was washed with DI water and ethanol. A solution of titanium isopropoxide (TIP) (60 ml ethanol, 5 ml acetylacetone and 10 ml TIP) was poured over the composite membrane and allowed to flow through under vacuum. The post-treated membrane was dried at 80° C. for 15 minutes and then placed into a 150° C. oven for 10 minutes with an open beaker of water to hydrolyze the titanium isopropoxide. The hydrolysis reaction formed internanowire bonds and the treated membrane was then calcined at 300° C. in air for 60 minutes.

The post-treated composite membrane had a water flux of 300 L/m²/h at 0.8 bar TMP and retained 53 nm dyed polystyrene latex beads. This method and the membrane so made provides for a thin retentive layer, here the potassium nanowire membrane layer. As is well know the flux of a symmetric membrane such as these increases with decreasing thickness. However, very thin membranes may not have sufficient strength to withstand module manufacturing processes or the rigors of a filtration process. The composite approach allows for a thin retentive membrane with the mechanical strength supplied by the more porous substrate layer.

### 9. Preparation of Reinforced Nanowire Membrane by Adding Glassfiber

The procedure of Example 6 was followed with the addition of 0.03 grams of dispersed glass fibers to the initial slurry. A membrane was made as described in Example 6 and found to have approximately twice the tensile strength of the dry membrane of 6.

### 10. Preparation of a Membrane Coated on a Substrate

Potassium titanate nanowire (0.1 g in dry TiO₂ form) was dispersed in 500 ml DI water by a household blender for 10 minute. 50 ml of the resultant slurry was filtered through a 37 mm glass fiber membrane (Sterlitech, Wash.) under vacuum. The membrane was then washed by DI water and ethanol in situ. The resulted membrane was then dried at 80° C. Its flux of DI water is 1210 L/m²/h at 0.8 bar TMP, and the membrane retains 53 nm dyed beads.

### 11. Post Treatment by Immersion

A dry sodium titanate nanowire membrane made as describe in Example 6. was briefly immersed in a titanium isopropoxide solution (60 ml ethanol, 5 ml acetylacetone—used as a complexing agent with the isopropoxide to slow down or prevent hydrolysis during fabrication—and 10 ml titanium isopropoxide) and the post treated membrane was dried at 80° C. for 15 minutes and then placed into a 150° C. oven for 10 minutes with an open beaker of water to hydrolyze the titanium isopropoxide. The hydrolysis reaction formed internanowire bonds and the treated membrane was then calcined at 300° C. in air for 60 minutes. The treated membrane has a tensile strength of 2.5 MPa compared to the membrane of Example 6 of 0.26 MPa.

### 12. Post-Treatment by Surface Spray of Titanium Isopropoxide

A dry sodium titanate nanowire membrane was made as described in Example 6. A solution of titanium isopropoxide (9 grams ethanol, approximately 8 grams of acetylacetone and 14 grams of titanium isopropoxide) was sprayed onto the surface of the membrane using a household finger pumped sprayer for three times. The post treated membrane was dried at 80° C. for 15 minutes and then placed into a 150° C. oven for 60 minutes with an open beaker of water to hydrolyze the titanium isopropoxide. The hydrolysis reaction formed internanowire bonds and the treated membrane was then calcined at 300° C. in air for 60 minutes. The membrane had a tensile strength of 1.44 MPa and did not redisperse when immersed in room temperature water and gently shaken. It had a water flux of 410 L/m²/h at 0.8 bar and could retain 480 nm dyed polystyrene latex beads.

### 13. Stabilization of Membrane by KOH Hydrothermal Treatment

A dry sodium titanate nanowire membrane was immersed in a 10M KOH solution in a PTFE lined pressure vessel. The vessel was sealed and placed into a convective oven (MTI Corp. CA) at 230° C. for several hours. After washing and drying the treated membrane was immersed in water and shaken, but did not fall apart, showing that the KOH treatment bonded the membrane nanowires together.

### 14. Using Reaction Coating to Bond Nanofibers

To 20 ml DI water was added 0.40 g wet sodium titanate nanowire paste (0.08 g dry TiO₂) and stirred to make a slurry. A solution of 0.08 g NaAlO₂ in 10 ml DI water was made. The NaAlO₂ solution was added dropwise to the nanowire slurry with stirring. The pH of the treated slurry was then adjusted with ˜10% sulfuric acid to pH=6˜7. The final solution is about 60 ml. 30 ml finished slurry was filtered to make a 37 mm membrane. The wet membrane was dried at 80° C. under a heat press, and was calcined at 300° C. for one hour. The resulting membrane passed the one inch rolling. Measured tensile strength was 5.4 MPa, and measured flux of DI water was 497 L/m²/h at 0.8 bar TMP. The membrane retained 480 nm dyed beads in a filtration test. The treated membrane was held in 90° C. water for three hours and retained its shape and integrity.

### Example 1

### Preparing Bonded Ceramic Nanowire Membranes Using Base Precipitated Salts

It is possible to make bonded ceramic nanowire membranes using suitable salts precipitated by bases. Suitable salts include Titanium oxysulfate, Aluminum nitrate, aluminum sulfate, zirconium sulfate, zirconium oxynitrate, aluminum chloride, and zirconium oxychloride.

The procedure is illustrated by the following example.

Prepare a solution (w/w) of the salt in water. Adjust pH to less than 7 as needed to assure complete dissolution. Combine with ceramic nanowires to make up a membrane forming slurry checking to maintain an acidic condition. Add sufficient strong base solution with vigorous stirring to precipitate the salt. This will result in a slurry of nanowires, precipitated salt and nanowires with salt precipitated or coated onto nanowires. The membrane is formed in the usual manner by filtration and washed thoroughly with water. The wet membrane is dried by heat pressing or in any of the usual ways (convective heated air, IR radiation, etc.). The dried membrane may be calcined at 250° C. to 350° C., or at higher temperatures, if needed.

### Example 2

### Preparing Bonded Ceramic Nanowire Membranes Using Metal Esters

It is possible to make nanowire membranes using suitable metal esters. For example, Titanium(IV) methoxide, Titanium(IV) ethoxide, Titanium(IV) propoxide, Titanium (IV) isopropoxide, Titanium(IV) butoxide, Titanium(IV) tert-butoxide, Titanium diisopropoxide bis(acetylacetonate), Titanium(IV) 2-ethylhexyloxide, Titanium(IV) tetrachloride, silicon chloride Tetramethoxysilane, Tetraethyl orthosilicate (TEOS), Tetra-n-propoxysilane, Silicon tetrabutanoxide, Silicon tetraacetate, Aluminum trimethoxide, Aluminum ethoxide, Aluminum tributoxide, Aluminum-tri-sec-butoxide, aluminum acetylacetonate, Zirconium(IV) ethoxide, Zirconium(IV) isopropoxide, Zirconium(IV) propoxide, Zirconium(IV) butoxide, Zirconium(IV) tert-butoxide, Zirconium acetate, Zirconium acetylacetonate.

The procedure is illustrated by the following example.

To an alcohol/water slurry consisting of ceramic nanowires is added an alcohol solution of a metal ester, for example, titanium isopropoxide (TIP) with stirring. The hydrolysis of the metal ester is brought about by heating or by lowering the pH to about 1-2, or raising ph to about 10-11. The relative amount of acetylacetone or other complexing agent is critical, because it must retard the hydrolysis reaction until initiation is desired but not slow down or stop hydrolysis once conditions (temperature, pH) are obtained to start the reaction. To initiate and continue the hydrolysis reaction the pH is adjusted to a range of from about 1 to about 4, preferably from about 1 to about 3, or is raised to a pH of from about 10 to about 14, preferably from about 11 to about 13. If temperature is used, the temperature is raised to a temperature that initiates and maintains the reaction to complete the hydrolysis.

Upon completion of hydrolysis the membrane is formed in the usual manner by filtration and washed thoroughly with water. The wet membrane is dried by heat pressing or in any of the usual ways (convective heated air, IR radiation, etc.). The dried membrane may be calcined at 250° C. to 350° C., or at higher temperatures, if needed.

### INCORPORATION BY REFERENCE

References and citations to other documents, such as patents, patent applications, patent publications, journals, books, papers, web contents, have been made in this disclosure. All such documents are hereby incorporated herein by reference in their entirety for all purposes.

### EQUIVALENTS

The representative examples are intended to help illustrate the invention, and are not intended to, nor should they be construed to, limit the scope of the invention. Indeed, various modifications of the invention and many further embodiments thereof, in addition to those shown and described herein, will become apparent to those skilled in the art from the full contents of this document, including the examples and the references to the scientific and patent literature included herein. The examples contain important additional information, exemplification and guidance that can be adapted to the practice of this invention in its various embodiments and equivalents thereof.

What is claimed is:

1. A ceramic membrane comprising bonded ceramic nanowires.

2. The ceramic membrane of claim 1, wherein the ceramic membrane is bendable.

3. The ceramic membrane of claim 2, wherein the bendable ceramic membrane passes the one inch diameter Bendability Test.

4. (canceled)

5. The ceramic membrane of claim 1, wherein the ceramic nanowires are made by a hydrothermal process.

6-8. (canceled)

9. The ceramic membrane of claim 5, wherein the ceramic nanowires comprise an inorganic titanate or a mixture of inorganic titanates.

10. The ceramic membrane of claim 5, wherein the ceramic nanowires comprise a sodium titanate, a potassium titanate, or a mixture of sodium and potassium titanates.

11. The ceramic membrane of claim 5, wherein the ceramic nanowires comprise an inorganic compound formed from the group consisting of silicon dioxide, zirconium oxide, aluminum oxide, and tungsten oxide.

12. The ceramic membrane of claim 1, wherein the bonded ceramic nanowires have a bond that comprises at least one titanium-oxygen link.

13. The ceramic membrane of claim 1, wherein the bonded ceramic nanowires have a bond that comprises at least one aluminum-oxygen link, at least one silicon-oxygen link, or at least one zirconium-oxygen link.

14-16. (canceled)

17. The ceramic membrane of claim 5 having a tensile strength of at least about 2.5 MPa.

18. The ceramic membrane of claim 5 having a tensile strength of greater than about 5.4 MPa.

19-21. (canceled)

22. The ceramic membrane of claim 1 having at least two bonded ceramic membrane layers integrally bonded.

23-45. (canceled)

46. The ceramic membrane of claim 2 having at least two bonded ceramic membrane layers integrally bonded.

47-54. (canceled)

55. A method of making a ceramic membrane comprising bonded ceramic nanowires, the method comprising the steps of:
a. wetting a ceramic membrane comprising unbonded ceramic nanowires with a solution containing at least a reactive bonding material and at least a solvent for said reactive bonding material;
b. removing said solvent to leave said reactive bonding material on or in the interstitial spaces of said unbonded ceramic nanowires;
c. causing said reactive bonding material to react and form a bonding substance joining at least two nanowires; and
d. optionally, heating the bonded nanowires of step c.

56-82. (canceled)

83. A method of making a ceramic membrane comprising bonded ceramic nanowires, the method comprising the steps of:
e. mixing ceramic nanowires with an aqueous solution of sodium aluminate or sodium silicate to form a dispersion;
f. adjusting pH of said dispersion to a range of about 7 to about 9;
g. holding said dispersion for a time and at a temperature to form a treatment on the nanowires;
h. forming a membrane from the treated nanowires; and
i. drying the membrane.

84. The membrane produced by the method of claim 83.

85. A method of making a ceramic membrane of bonded ceramic nanowires, the method comprising the steps of:
a. preparing a dispersion of ceramic nanowires in a liquid carrier;
b. Adding preformed one or more bonding ceramic agents or one or more in situ formed ceramic bonding agents in the dispersion;
c. removing the liquid carrier from the dispersion thereby forming a porous membrane comprising ceramic nanowires; and
d. drying the membrane to form a membrane comprising bonded ceramic nanofibers.

86. The method of claim 85, wherein the preformed one or more ceramic bonding agents is a ceramic sol, colloidal silica, or aluminum sol.

87-94. (canceled)

95. A method of making a ceramic membrane comprising bonded ceramic nanowires, the method comprising the steps of:
j. mixing ceramic nanowires with a aqueous alcoholic solution of a metal ester salt and a complexing agent to form a dispersion;
k. causing the metal ester to undergo a hydrolysis reaction so as to form a slurry of nanowires, hydrolyzed metal ester, and nanowires with attached hydrolyzed metal ester;
l. forming a membrane from the slurry of step b;
m. drying the membrane; and
n. optionally calcining the membrane.

96. The method of claim 95, wherein the complexing agent is acetylacetone.

97-117. (canceled)
